(19) United States
(12) Patent Application Publication
(10) Pub. No.: US 2010/0162576 A1
(43) Pub. Date: Jul. 1, 2010

(54) FOOD PEELER

(76) Inventor: Thomas John Scimone, Campbell, CA (US)

Correspondence Address: John Nielsen;RANDICK O'DEA & TOOLIATOS, LLP, 5000 HOPYARD ROAD, SUITE 400, PLEASANTON, CA, 94588, US

(21) Appl. No.: 12/345,226

(22) Filed: Dec. 29, 2008

(51) Int. Cl. A47J 17/02; B26B 1/00; B26D 7/26

(52) U.S. Cl. 30/279.6; 30/330; 83/698.31

(57) ABSTRACT

Disclosed is a food peeler that has a longitudinally aligned conical body having upper and lower sections, and a recess in the upper half thereof in which a blade is rotatably mounted. The recess defines an area having a flat base and opposed, parallel, vertical sides. The blade is fixed to a blade holder that is rotatably mounted between the opposing vertical sides of the recess. The position of the blade holder can be reversed thereby enabling the peeler to be used by a right handed or left handed person.

### BACKGROUND OF THE INVENTION

A. Field of Invention

This invention relates to a food peeler which is useful in the kitchen to peel fruits such as apples, and vegetables such as potatoes, cucumbers, and the like. More particularly, it relates to a fruit and vegetable peeler that is conical in shape and which provides efficient removal of the skin and outer layers of common fruits and vegetables for both left and right handed individuals.

B. Description of Related Art

There are many fruit and vegetable peelers presently sold in the United States. Many of such peelers are patented. See, for example, U.S. Pat. Nos. 7,415,769; 7,077,058; 6,874,236; 6,854,383; 6,671,965; 6,327,971; 6,125,744; 5,865,110; and 5,845,565, to name a few.

A common problem with food peelers in general is that they tend to clog up with portions of the peels that are removed by the blades of the peelers. This is an undesirable situation, as it requires frequent cleaning of the blade and peeler, and is frustrating to the user of the peeler, as it impairs efficient use of it. Moreover, food peelers are mostly designed for right handed people, and that provides a problem for those who are left handed. What is needed is a food peeler that can be used equally efficiently by a right or left handed individual.

### SUMMARY OF THE INVENTION

The present invention relates to a food peeler that has a conically shaped body which has a recess in it holding a blade holder, containing a blade. The position of the blade holder can be easily reversed, so that it is equally adaptable for use by a right or left handed individual. The blade holder containing a fixed blade is rotatable around an axis that is at an angle with respect to the longitudinal axis of the peeler. Because the blade holder, and thus the blade, is rotatable, it enables the user to keep the pathway clear for removed peel portions to exit the peeler, thereby enabling the peeling process to be more efficient. The rotatable blade holder provides great flexibility for the peeler to be used with a wide variety of fruits and vegetables whose skin surface may vary widely in thickness and texture.

It is an object of this invention to provide an improved food peeler that has a rotatable blade holder containing a blade mounted thereon that allows peeled material to exit from the peeler in an efficient manner.

It is a further object of the invention to provide an improved fruit and vegetable peeler that is efficient in removing skin surfaces from fruits and vegetables, and other objects.

It is a further object of the invention to provide a food peeler that can easily be adapted for use by a left handed or right handed person.

These and other objects will be apparent from the description to follow.

### BRIEF DESCRIPTION OF THE DRAWINGS

FIG. 1 is a perspective view of the food peeler of the invention.

FIG. 2 is an exploded view of the food peeler of the invention.

FIG. 3 is an enlarged view of a section of the peeler of the invention showing the blade holder and blade positioned within the body of the peeler.

FIG. 4 is top view of the blade and blade holder of the peeler of the invention.

FIG. 5 is a view, partially in cross section, through the line 5-5 of FIG. 1.

FIG. 5A is another view, partially in cross section, through the line 5-5 of FIG. 1, showing the blade holder containing a blade in a position resting against a stop.

FIG. 5B is another view, partially in cross section, through the line 5-5 of FIG. 1, showing the blade holder containing a blade in another position resting against a stop.

FIG. 6 is a view, partially in cross section, through the line 6-6 of FIG. 1.

FIG. 6A is another view, partially in cross section, through the line 6-6 of FIG. 1 showing the blade holder containing a blade in another position resting against a stop.

FIG. 6B is another view, partially in cross section, through the line 6-6 of FIG. 1, showing the blade holder containing a blade in another position resting against a stop.

### DESCRIPTION OF THE PREFERRED EMBODIMENT

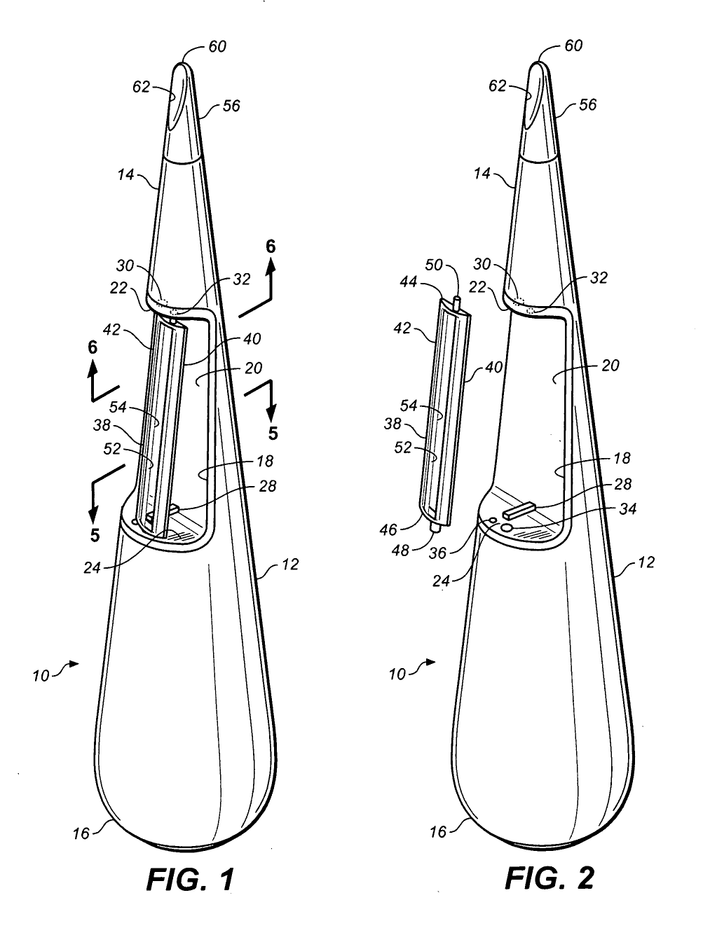

The food peeler 10 of this invention is shown best in FIGS. 1 and 2. As seen in FIG. 1, the peeler 10 comprises a round, conically shaped, tapered body 12 that has a longitudinal axis, and opposed top and bottom ends 14, and 16.

The conically shaped body 12 tapers inward from the bottom end 16 to the top end 14. Thus, the diameter of the body 12 at the maximum width near the bottom end 16 is substantially greater than the diameter at the top end 14. In the preferred embodiment, the diameter of the body 12 at its maximum width near the bottom end 16 is about one and one-quarter inches, while the diameter of the body 12 at the top end 14 is about one/half inch. The length of the entire body is preferably about seven and three eighths inches. The lower half of the body 12, serves as a handle for the peeler. Preferably, the bottom end 16 has a flat bottom surface, so that the peeler can be stood upright on it.

A U-shaped recess 18 is cut into the body 12 at a point beginning about ½ of the distance between the bottom end 16, and the top end 14, and extending therefrom toward the top end 14. The recess 18 defines an area having a substantially flat base surface 20, and opposed parallel vertical walls, 22 and 24. Recess 18 is preferably about 2 inches in length, and the vertical walls, 22 and 24 are about ½ inches high, and ¾ inches high, respectfully. The wall 24 closest to the bottom end 16 of the body 12 is higher than the wall 22 closest to the top end 14, due to the tapering of the body 12 from a thicker bottom end 16 to a smaller top end 14. As best seen in FIGS. 2, 5, 5A, 5B, and 6, 6A and 6B, rectangular vertical stops 26, and 28, project outward from each of the walls 22 and 24. The stops 26 and 28 extend vertically from the midline axis of the body 12, and extend about half the distance up the walls 22 and 24, respectfully. A pair of holes 30, 32 are cut into the upper portion of wall 22, and another pair 34, 36 are cut into the opposite wall 24. The holes 30, 32 lie on the same horizontal plane on opposite sides of the vertical extension of the midline axis of the body 12, and are of slightly different diameter. As seen in FIGS. 6, 6A, and 6B, hole 30 has a larger diameter than hole 32. The holes 34, 36 are cut into the face of the vertical wall 24. The holes 34, 36 also lie on the same horizontal plane on opposite sides of the imaginary vertical extension of the midline axis of the body 12. Hole 34 is of slightly larger diameter than hole 36.

A blade holder 38 is rotatably mounted within the recess 18. The blade holder 38 comprises an elongated rectangular frame, open to the interior, with opposing sides 40, and 42, and opposing ends 44 and 46. The opposing sides 40, 42, and opposing ends 44, 46 define an open interior space. As best seen in FIGS. 2, 5, and 6, the ends 44 and 46 of the blade holder 38 arch upwardly from the sides to the middle thereof, with the high point or apex of the arch being in the middle. Thus the angle of elevation of the ends of the blade holder is about 30 degrees from each side toward the middle. A pin 48 projects from one end of the blade holder 38, and another pin 50 projects from the opposite end of the blade holder 38. The pins 48 and 50 project outwardly from each end of the blade holder 38 at the apex thereof. The diameter of pin 48 is larger than the diameter of pin 50. Pin 48 is adapted to fit into either of holes 30 or 34, while pin 50 is adapted to fit into either of holes 32 or 36. Thus, as seen in FIG. 2, the larger diameter pin 48 of the blade holder 38, fits into the larger diameter hole 34 in the wall 24, while the smaller diameter pin 50 fits into hole 32. The reason for this is so that the orientation of the blade holder 38, and thus the blade described below can be easily adjusted whether the user is a right handed or left handed person. The pins 48 and 50 have the same axis of rotation.

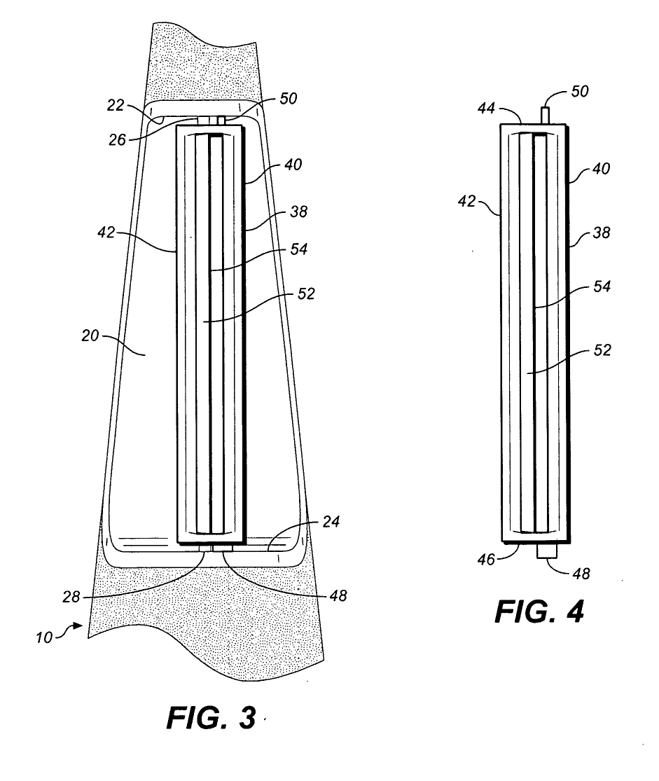

As seen particularly in FIGS. 2, 3 and 4, an elongated, rectangular blade 52 having a sharp edge 54 is fixed to one side 42 of the blade holder 38, with its sharp edge 54 projecting inward into the interior open space of the holder 38 defined by the sides 40, 42, and ends 44, 46. The blade 52 has the same upward angle of elevation as does the ends 44, and 46 of the blade holder 38. The blade 52 is preferably made of ceramic, but can also be made of steel if desired.

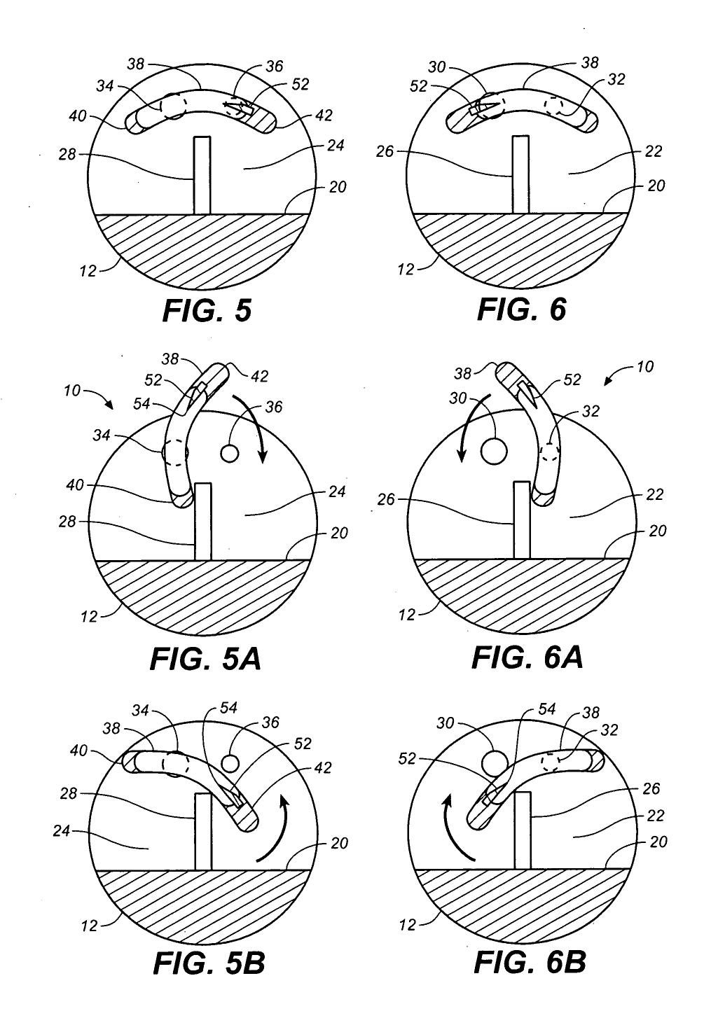

The blade holder 38, and thus the blade 52, is rotatable around the axis of rotation of the pins 48 and 50 extending from the ends 46, and 44 respectively. The extent of rotation is limited by the projections or stops 26 and 28 projecting inwardly from the vertical walls 22, and 24. See, for example, FIGS. 5, 5A, and 5B, showing various positions of the blade holder 38, as it is rotated around the axis of the pins 48 and 50.

A notable feature of the peeler of the invention is that the position of the blade holder 38, and thus the blade 52 can be reversed with respect to the body 12, so that it can be easily used by a left or right handed person. Thus, if a person is right handed, the blade holder 38 is mounted with pin 48 inserted into hole 34, and pin 50 inserted into hole 32. For a left handed person, the position of the blade holder 38 is reversed with respect to the recess, and pin 48 is inserted into hole 30, and pin 50 inserted into hole 36.

When an individual desires to peel a fruit or vegetable, the body 12 is grasped with the hand, at a point between the recess 18 and the bottom end 16, and the sharp edge 54 of the blade 52 is placed in contact with the surface of the fruit or vegetable. The peeler 10 is then urged toward the user. The blade edge 54 engages the surface of the fruit or vegetable, and the blade holder 38 moves the blade 54 around its axis, until movement is restricted as the holder 38 comes into contact with, and abuts the projections 26, 28 on each side. The skin of the fruit or vegetable being peeled slides through the space between the sharp edge 54 of the blade, and the inner edge of the opposing side 40 of the blade holder 38.

In a preferred embodiment of the invention, as seen in FIG. 1, and 2, the body 12 has an extension at the top thereof which is called an eyer 56. The eyer 56 has a sharp point 60 and a scooped out surface, forming a bowl 64. The purpose of the eyer 56 is to enable the user to remove specific areas of rot from fruits or vegetables either before, during or after the peeling process. The eyer 56 is an optional feature of the food peeler 10 of this invention.

The peeler 10 of this invention can be stored in a drawer, or, if desired, it can be used as a decorative item, and stood upright on the flat bottom surface of the bottom end 16.

It will be recognized by those skilled in the art that various modifications can be made in the peeler described herein without departing from the scope and spirit of the invention.

I claim:

1. A food peeler comprising:
a. a conically shaped body having a longitudinal axis;
b. a recess in said body defining an opening therein, and
c. a blade rotatably mounted in said recess.

2. The food peeler of claim 1 wherein the position of said blade in said recess is reversible, thus making it operable for a left or right handed person.

3. The food peeler of claim 1 wherein said body has a lower half and an upper half, and wherein said recess is situated in the upper half of said body.

4. The food peeler of claim 1 wherein said recess defines a U-shaped opening having a flat base, and opposed parallel side walls.

5. The peeler of claim 4 wherein each of said side walls has a pair of holes in it, aligned on the same horizontal plane, and spaced one on each side of am imaginary vertical axis of said body, said pair of holes having different diameters.

6. The peeler of claim 5 further containing a blade holder pivotally mounted so as to rotate around the axis of said holes.

7. The peeler of claim 6 wherein said blade holder comprises a rectangular frame defining an open space in the middle.

8. The peeler of claim 7 wherein a blade is attached to one side of said frame and projects into said open space.
